(19) United States
(12) Patent Application Publication
(10) Pub. No.: US 2025/0148284 A1
(43) Pub. Date: May 8, 2025

(54) METHOD AND SYSTEM FOR PERFORMING AN OPTIMIZED NEURAL NETWORK ARCHITECTURE SEARCH

(71) Applicant: Robert Bosch GmbH, Stuttgart (DE)

(72) Inventors: Tal Dekel, Ramat Gan (IL); Valentin Poirot, Stuttgart (DE)

(21) Appl. No.: 18/930,190

(22) Filed: Oct. 29, 2024

(30) Foreign Application Priority Data
Nov. 8, 2023 (DE) 10 2023 211 085.7

(51) Int. Cl. G06N 3/082; G06F 8/35; G06N 3/0495

(52) U.S. Cl. CPC G06N 3/082; G06F 8/35; G06N 3/0495

(57) ABSTRACT

A method for performing an optimized Neural Network Architecture Search (NAS). The method includes: providing a technical problem definition, the technical problem to be solved by a to be searched set of candidate neuronal networks, a training dataset, a search space and preferably a seed neuronal network architecture; training, by the NAS-process, each one of the set of candidate neuronal networks based on the at least a part of the training dataset; adjusting and/or fine-tuning, by the NAS-process, a network architecture of each one of the set of trained candidate neuronal networks via Quantization-Aware Training; converting, by the NAS-process, the respectively adjusted and/or fine-tuned network architecture of each one of the set of candidate neuronal networks to a framework.

### CROSS REFERENCE

The present application claims the benefit under 35 U.S.C. § 119 of German Patent Application No. DE 10 2023 211 085.7 filed on Nov. 8, 2023, which is expressly incorporated herein by reference in its entirety.

### FIELD

The present invention relates to a computer-implemented method for performing an optimized Neural Network Architecture Search. The present invention relates to a system for performing an optimized Neural Network Architecture Search. The present invention relates to a target hardware device. The present invention relates to a computer program comprising program code and a computer-readable medium containing program code of a computer program.

### BACKGROUND INFORMATION

Neural Architecture Search (NAS) is considered to be a general concept of automatic network architecture generation based on training data and an objective function. Such NAS is well established in the literature. For example, multi-objective NAS is available, which refers to automatic network architecture generation based on jointly optimizing key performance indicators from training data. Also, Hardware-Aware NAS is available, in which automatic network architecture generation is made with the goal of optimizing for a given target hardware (HW). Such Hardware-Aware NAS is often done via proxy metrics (for example, number of parameters) or heuristics (see, for example, arxiv.org/pdf/2101.09336.pdf).

Also, the process of quantization is described in literature. Thereby, quantization refers to a process of converting network parameters (weights) and intermediate results (activations) from real numbers (typically 32-bit float numbers) to a smaller representation that is often given in an integer format, typically 8-bit integers. In literature, also 2, 3, 4, or 16-bit formats are presented. However, quantization is well known to introduce performance degradation, e.g., the accuracy in image classification or object detection is degraded due to the smaller information representation of quantized networks). Solutions to mitigate, but not eliminate, quantization performance-degradation exist in the literature, see

Quantization-Aware Training (QAT) (arxiv. org/pdf/1712. 05877. pdf).

According to a general NAS process, the user provides a problem definition (losses to minimize), a training dataset, a search space, and possibly a seed architecture. The NAS tool then generates a set of candidate network-architectures. For each candidate, the NAS tool trains the architecture on the training dataset (or a subset of the dataset). The NAS tool then performs an evaluation of the candidate architecture regarding provided key performance indicators. The candidate is added to and an assembly of evaluated architectures is made, out of which a subset is defined as “Pareto front”. Thereby, a Pareto front is a set of Pareto efficient solutions. It allows the designer to restrict attention to the set of efficient choices, and to make a tradeoff within this set, rather than considering the full range of every parameter. The candidate is added to a Pareto front of candidate architectures. The NAS tool provides the Pareto front to the end-user. The end-user selects their favorite candidate architectures. If the end-user wants to deploy the selected architecture, it goes through successive steps (including, but not limited to, quantization and code generation), to deploy the architecture on a target hardware and measure its performance on the target hardware.

Thus, to repeat once again, the NAS process aims at finding network architectures that jointly optimize key performance indicators defined by an end-user. Such an indicator may be, for example, a memory size required for network deployment, network minimal accuracy, network delay, system throughput, or the like. The end-user may also provide a seed network architecture or indicate the problem type, training data, a problem definition (e.g., what should the AI network do, losses to minimize), and a search space to the NAS tool. Thereby, the search space is a virtual space that includes all possible relevant network configurations that have identical input and output but use different layers to generate the same output with different performances and accuracies. The seed network is a possible solution to the problem definition, but is too big in memory, too slow in execution runtime and/or contains non-supported operations and cannot be deployed to a target hardware or just be a network with average performance, which performance shall, however, be optimized.

The NAS process's goal is to generate candidate network architectures that fulfill these requirements (e.g., memory, runtime, supported operations) on a target hardware. As already rolled out, the generated network architectures are often depicted on a Pareto Front, mapping network architectures to the different key performance indicators.

Many target hardware (for example, but not limited to, in the industrial and consumer domains) do not support running the selected generated network architecture as-is.

Some target hardware (like microcontrollers and/or embedded hardware) are more efficient at executing network models quantized in integer format, rather than the original floating-point representation.

In most existing solutions, the end-user goes through a deployment process to deploy and run the network architecture on the target hardware. Such a deployment process may contain a quantization step (going from float to, e.g., integer), a model conversion step (e.g., going from TensorFlow or PyTorch to

TFLite or ONNX), and a code generation step (going from the converted model to, e.g., C-code or a binary file). Each of these steps in the deployment process typically contain additional optimizations (for example, operation fusion), that transform the network architecture to a new architecture (not a one-to-one mapping) that may introduce additional degradation and/or effects on the performance of the network architecture. For example, model conversion may cause grave performance degradation for recurrent models (architectures that contain RNNs, LSTMs, GRUs, or similar operations).

Generally, it can be said that the Pareto front of candidate architectures is not representative of the performance of architectures that went through the entire deployment process. The solution space, i.e., the Pareto front, of quantized architectures can be seen as an entirely different space of the solution space generated by the NAS process, meaning that a non-quantized network that may appear on the Pareto front will not perform that well after quantization due to the inherent loss/degradation resulting from the quantization process. The loss/degradation is not linear, so different network layers with different quantization will generate different losses/degradations.

Thus, the current state-of-the-art solutions try to deal with quantization in NAS do not fully capture all the characteristics of quantization degradation. For example, their Pareto front is still distorted regarding the Pareto front that would be obtained by introducing all deployment steps in the NAS process. Also, they lack tools to optimize the quantization step in their NAS process, or their tools are not efficient at adapting quantization for specific problem domains and/or for specific, quantization-critical operations, i.e., network layers heavily affected by quantization.

Therefore, further development is required.

An object of the present invention is to provide an improved method of Neural Network Architecture Search (NAS) that is preferably quantization-degradation-aware.

The task is solved by a computer-implemented method for performing an optimized Neural Network Architecture Search according to certain features of the present invention. The task is solved by a system for performing an optimized Neural Network Architecture Search according to certain features of the present invention.

### SUMMARY

According to a first aspect of the present invention, a computer-implemented method for performing an optimized Neural Network Architecture Search (NAS) is provided. According to an example embodiment of the present invention, the method comprises the steps of:
providing a technical problem definition, the technical problem to be solved by a to be searched set of candidate neuronal networks, a training dataset, a search space and preferably a seed neuronal network architecture;
generating the set of candidate neuronal networks by a NAS-process based on at least the provided problem definition and/or the search space and/or the preferred seed neuronal network architecture;
selecting, by the NAS-process, quantization characteristics for quantization of each one of the set of candidate neuronal networks based on at least the provided problem definition and/or expert knowledge, preferably to mitigate performance-degradation due to quantization;
training, by the NAS-process, each one of the set of candidate neuronal networks based on the at least a part of the training dataset;
adjusting and/or fine-tuning, by the NAS-process, a network architecture of each one of the set of trained candidate neuronal networks via Quantization-Aware Training (QAT);
converting, by the NAS-process, the respectively adjusted and/or fine-tuned network architecture of each one of the set of candidate neuronal networks to a framework;
generating, by the NAS-process, software code for each one of the converted set of candidate neuronal networks;
evaluating a performance for each one of the code-generated set of candidate neuronal networks; and
providing the evaluated set of candidate neuronal networks for selection of at least one neuronal network usable for solving the technical problem.

It is understood that the steps according to the present invention, as well as further optional steps, do not necessarily have to be carried out in the sequence shown, but can also be carried out in a different sequence. Furthermore, further intermediate steps may be provided. Moreover, the individual steps may comprise one or more sub-steps without thereby leaving the scope of the method according to the present invention.

The user of the NAS-tool may preferably provide a technical problem definition, e.g., but not limited to, losses to minimize. Also, the user may provide a training dataset, a search space and seed architecture to the NAS-tool for further execution. For each candidate, the NAS-tool trains the neuronal network architecture on the training dataset or a subset of the provided training dataset.

The present solution can generate network architectures that mitigate the performance degradation of quantization and/or contains methods to drive the application and/or optimization of quantization to network architectures. The present solution generates a Pareto front of candidate network-architectures that are quantized and went through the entire deployment process within the NAS process. Thus, these candidate network-architectures are representative of the performance of deployed models on a target hardware.

The present invention relates to an improved NAS-process/method regarding finding quantized neuronal networks. Therefore, it is proposed that expert knowledge be incorporated regarding suitable quantization properties, thereby effectively and/or efficiently reducing the neuronal network search space. The improved NAS method is also hardware-aware, as it may consider hardware limitations of at least one hardware component in the NAS-tool.

According to the present invention, all optimization steps (training, quantization-aware fine-tuning, model conversion to TFLite/ONNX, operations fusion, C code generation are included within one NAS-process.

In an example embodiment of the present invention, the expert knowledge includes information about at least one of quantization-sensitive layers of the generated neuronal network architectures, supported layers of the generated neuronal network architectures, at least one hardware definition and/or sensitivity, computation and hardware support for specific operations and quantization schemes, wherein the expert knowledge is preferably provided as a lookup table accessible by the NAS-process. The NAS-tool generates based on this information a set of candidate neuronal network-architectures. Thereby, the present NAS-tool may automatically select quantization characteristics based on the provided problem definition and expert knowledge about layers that can be affected the most by quantization, and how to mitigate these effects. The NAS-tool is, thus, aware of supported layers, efficient operations to select, and has rules to mitigate the performance-degradation due to quantization. The NAS-tool may further be provided with hardware definition and sensitivity in terms of layer performance degradation, computation, hardware support for specific operations and quantization schemes and/or supported layers. According to the present invention, expert knowledge in the form of an analysis of frameworks, a target hardware device, required layers and/or problem domain may be considered. The information may be provided as a lookup table that identifies supported or not-supported layers, quantization schemes, layers, problem definition and maps it to potential quantization schemes and parameters.

Preferably, the NAS-tool selects operations (e.g., layers), quantization schemes/parameters based on the lookup table and operations supported by the hardware device. For example, soft max, gelu requires many operations like exponential which are hard to run on devices and quantize. Also, as an example, recurrent layers have exploding errors due to dependencies on pastime steps. Also, quantization causes small variation errors, when taken over time, wherein these errors accumulate and multiply, leading to poor performance of the neuronal network.

In an example embodiment of the present invention, the Quantization-Aware Training includes a process where layers emulate the behavior of quantized operations during a forward pass, whereas remaining in float during a backward pass. The NAS-tool further executes a fine-tuning of the network architecture via Quantization-Aware Training (QAT), a process where layers emulate the behavior of quantized (integer) operations during the forward pass, but remain in float during the backward pass (arxiv. org/pdf/1712. 05877. pdf).

In an example embodiment of the present invention, the framework comprises a tensorFlow and/or a PyTorch to ONNX and/or a TFLite framework, wherein the converting preferably comprises an operation fusion and/or further optimization steps. In other words, the NAS tool proceeds to the network-architecture conversion step, e.g., going from a model trained in typical frameworks: tensorFlow and/or PyTorch to ONNX and/or TFLite, including typical operation fusion and/or other optimizations. After that, the NAS-tool preferably proceeds to the code generation step, preferably including any optimization specifics to a used code generation tool.

In an example embodiment of the present invention, evaluating the performance of each one of the code-generated set of candidate neuronal networks includes executing each one of the code-generated set of candidate neuronal networks on a target hardware device. The NAS-tool preferably evaluates the quantized and deployable neuronal network(s) on a fully deployable architecture, preferably locally for fast measurement of performance. Alternatively, the architecture may be executed on a target hardware device, so-called hardware-in-the-loop, for a slower but accurate performance measurement. All effects of quantization, optimizations, and modifications inherent to architecture conversion and code generation steps may be preferably represented in a final Pareto front as an output of the NAS-process. The candidate neuronal network may thus be added to a quantized-aware Pareto front of candidate architectures. The NAS-tool may provide the Pareto front to the end-user. The end-user may select a preferred candidate architecture for a neuronal network. The end-user can directly deploy the selected neuronal network on the target hardware device. Thereby, the target hardware device can be run using a neuronal network having an architecture optimized for the hardware device specifications. Thereby, an optimized performance of the neuronal network and/or the target hardware device can be achieved.

A Pareto front is a concept from the field of multi-objective optimization. In a multi-objective optimization problem, there are typically several conflicting objectives that need to be optimized simultaneously. A solution is considered to be Pareto optimal if no other feasible solutions exist that can make one objective better without making at least one other objective worse. The Pareto front (or Pareto frontier) is the set of all Pareto optimal solutions in the objective space. When visualized, it represents the boundary where no improvements can be made to one objective without sacrificing performance in another objective.

In an example embodiment of the present invention, providing the evaluated set of candidate neuronal networks includes providing a quantized-aware Pareto front of candidate architectures of the evaluated set of candidate neuronal networks, the method may further comprise selecting at least one of the candidate neuronal networks as a trained, evaluated, quantized neuronal network deployable on a target hardware device.

According to an example embodiment of the present invention, preferably, knowledge of a problem domain is provided. For example, for auto-encoders and image segmentation, more fine-grained quantization (16 bit, 32 bit instead of 8) is needed, as information is essential at the very beginning and very end of the network architectures and/or other critical places within the architecture. Preferably, domain knowledge is provided, as sequencing/dependencies of past layers is essential (time-wise and depth-wise), beginning and end of network are important, recurrent layers are critical. Lookup tables that identify critical layers and apply different quantization schemes to mitigate performance degradation as particularly preferable. Such a lookup table may be applied to identify critical layers and possible quantization schemes/mitigation methods. The NAS-tool may automatically select mitigation methods and may also apply them.

According to a second aspect of the present invention, a target hardware device, in particular a microcontroller or a system on a chip, is provided including an evaluation and computing device and/or at least one processor, the evaluation and computing device and/or the at least one processor being configured to deploy the at least one selected neuronal network.

According to an example embodiment of the present invention, a controller is also provided which is comprised in an autonomous vehicle and/or a robotic system and/or an industrial machine, and on which the at least one selected neuronal network is executable.

According to a third aspect of the present invention, a system for performing an optimized Neural Network Architecture Search (NAS) is provided. According to an example embodiment of the present invention, the system comprises an evaluation and computing device configured to perform the following steps:
providing a technical problem definition, the technical problem to be solved by a to be searched set of candidate neuronal networks, a training dataset, a search space and preferably a seed neuronal network architecture;
generating the set of candidate neuronal networks by a NAS-process based on at least the provided problem definition and/or the search space and/or the preferred seed neuronal network architecture;
selecting, by the NAS-process, quantization characteristics for quantization of each one of the set of candidate neuronal networks based on at least the provided problem definition and/or expert knowledge, preferably to mitigate performance-degradation due to quantization;
training, by the NAS-process, each one of the set of candidate neuronal networks based on the at least a part of the training dataset;
adjusting and/or fine-tuning, by the NAS-process, a network architecture of each one of the set of trained candidate neuronal networks via Quantization-Aware Training (QAT);
converting, by the NAS-process, the respectively adjusted and/or fine-tuned network architecture of each one of the set of candidate neuronal networks to a framework;
generating, by the NAS-process, software code for each one of the converted set of candidate neuronal networks;
evaluating a performance for each one of the code-generated set of candidate neuronal networks; and
providing the evaluated set of candidate neuronal networks for selection of at least one neuronal network usable for solving the technical problem

The statements made for the procedure of the present invention apply accordingly to the system of the present invention. It is understood that linguistic modifications of features formulated in accordance with the procedure can be reformulated for the system in accordance with standard linguistic practice without such formulations having to be explicitly listed here.

Also provided according to present the present invention is a computer program comprising program code to execute at least parts of the method according to the present invention in one of its embodiments, when the computer program is executed on a computer. In other words, according to the present invention, a computer program (product) comprising instructions which, when the program is executed by a computer, cause the computer to execute the method/steps of the method according to the present invention in one of its embodiments.

According to an example embodiment of the present invention, a computer-readable medium comprising program code of a computer program is also provided for executing at least parts of the method according to the present invention in one of its embodiments when the computer program is executed on a computer. In other words, the present invention relates to a computer-readable (storage) medium comprising instructions which, when executed by a computer, cause the computer to execute the method/steps of the method according to the present invention in one of its embodiments.

The described embodiments and further developments can be combined with each other as desired.

Further possible embodiments, further developments and implementations of the present invention also comprise combinations of features of the present invention described before or below regarding the embodiments that are not explicitly mentioned.

### BRIEF DESCRIPTION OF THE DRAWINGS

The figures are intended to provide a further understanding of embodiments of the present invention. They illustrate embodiments and, in connection with the description, serve to explain principles and concepts of the present invention.

Other embodiments and many of the advantages mentioned will result regarding the figures. The elements shown in the figures are not necessarily shown to scale with each other.

FIG. 1 shows a schematic flowchart of a method according to the present invention.

### DETAILED DESCRIPTION OF EXAMPLE EMBODIMENTS

In the figures, identical reference signs designate identical or functionally identical elements, parts or components, unless otherwise indicated.

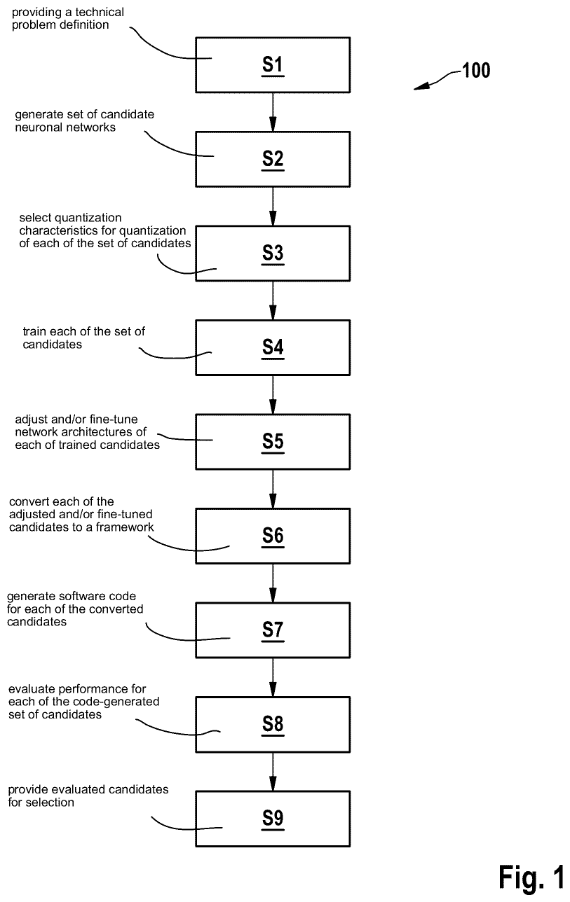

FIG. 1 shows a schematic flowchart of a computer-implemented method for performing an optimized Neural Network Architecture Search (NAS),

In any embodiment, the method can be carried out at least in part by a system 100, which for this purpose can comprise several components not shown in more detail, for example one or more provisioning devices and/or at least one evaluation and computing device. It is understood that the provisioning device may be formed together with the evaluation and computing device, or may be different therefrom. Furthermore, the system may comprise a storage device and/or an output device and/or a display device and/or an input device.

According to the present invention, the computer-implemented method comprises at least the following steps:

In a step S1, it occurs providing a technical problem definition, the technical problem to be solved by a to be searched set of candidate neuronal networks, a training dataset, a search space and preferably a seed neuronal network architecture

In a step S2, it occurs generating the set of candidate neuronal networks by a NAS-process based on at least the provided problem definition and/or the search space and/or the preferred seed neuronal network architecture.

In a step S3, it occurs selecting, by the NAS-process, quantization characteristics for quantization of each one of the set of candidate neuronal networks based on at least the provided problem definition and/or expert knowledge, preferably to mitigate performance-degradation due to quantization.

In a step S4, it occurs training, by the NAS-process, each one of the set of candidate neuronal networks based on the at least a part of the training dataset.

In a step S5, it occurs adjusting and/or fine-tuning, by the NAS-process, a network architecture of each one of the set of trained candidate neuronal networks via Quantization-Aware Training (QAT).

In a step S6, it occurs converting, by the NAS-process, the respectively adjusted and/or fine-tuned network architecture of each one of the set of candidate neuronal networks to a framework.

5 In a step S7, it occurs generating, by the NAS-process, software code for each one of the converted set of candidate neuronal networks.

In a step S8, it occurs, evaluating a performance for each one of the code-generated set of candidate neuronal networks.

In a step S8, it occurs, providing the evaluated set of candidate neuronal networks for selection of at least one neuronal network usable for solving the technical problem.

What is claimed is:

1. A computer-implemented method for performing an optimized Neural Network Architecture Search (NAS), the method comprising the following steps:
providing a technical problem definition, technical problem to be solved by a to be searched set of candidate neuronal networks, a training dataset, a search space, and a seed neuronal network architecture;
generating the set of candidate neuronal networks by a NAS-process based on at least the provided problem definition and/or the search space and/or the seed neuronal network architecture;
selecting, by the NAS-process, quantization characteristics for quantization of each one of the set of candidate neuronal networks based on at least the provided problem definition and/or expert knowledge;
training, by the NAS-process, each one of the set of candidate neuronal networks based on the at least a part of the training dataset;
adjusting and/or fine-tuning, by the NAS-process, a network architecture of each one of the set of trained candidate neuronal networks via Quantization-Aware Training (QAT);
converting, by the NAS-process, the adjusted and/or fine-tuned network architecture of each one of the set of candidate neuronal networks to a framework;
generating, by the NAS-process, software code for each one of the converted set of candidate neuronal networks;
evaluating a performance for each one of the code-generated set of candidate neuronal networks; and
providing the evaluated set of candidate neuronal networks for selection of at least one neuronal network usable for solving the technical problem.

2. The method of claim 1, wherein the expert knowledge includes information about at least one of: quantization-sensitive layers of the generated neuronal network architectures, supported layers of the generated neuronal network architectures, at least one hardware definition and/or sensitivity, computation and hardware support for specific operations, and quantization schemes, and wherein the expert knowledge is provided as a lookup table accessible by the NAS-process.

3. The method of claim 1, wherein the Quantization-Aware Training includes a process where layers emulate a behavior of quantized operations during a forward pass, whereas remaining in float during a backward pass.

4. The method of claim 1, wherein the framework includes a tensorFlow and/or a PyTorch to ONNX and/or a TFLite framework, and wherein the converting includes an operation fusion and/or further optimization steps.

5. The method of claim 1, wherein the evaluating of the performance of each one of the code-generated set of candidate neuronal networks includes executing each one of the code-generated set of candidate neuronal networks on a target hardware device.

6. The method of claim 1, wherein the providing of the evaluated set of candidate neuronal networks includes providing a quantized-aware Pareto front of candidate architectures of the evaluated set of candidate neuronal networks, and wherein the method further comprises selecting at least one of the candidate neuronal networks as a trained, evaluated, quantized neuronal network deployable on a target hardware device.

7. A target hardware device including a microcontroller or a system on a chip, the target hardware device comprising:
an evaluation and computing device and/or at least one processor, the evaluation and computing device and/or the at least one processor being configured to deploy a selected neuronal network, the neuronal network being selected by:
providing a technical problem definition, technical problem to be solved by a to be searched set of candidate neuronal networks, a training dataset, a search space, and a seed neuronal network architecture,
generating the set of candidate neuronal networks by a Neural Network Architecture Search (NAS)-process based on at least the provided problem definition and/or the search space and/or the seed neuronal network architecture,
selecting, by the NAS-process, quantization characteristics for quantization of each one of the set of candidate neuronal networks based on at least the provided problem definition and/or expert knowledge,
training, by the NAS-process, each one of the set of candidate neuronal networks based on the at least a part of the training dataset,
adjusting and/or fine-tuning, by the NAS-process, a network architecture of each one of the set of trained candidate neuronal networks via Quantization-Aware Training (QAT),
converting, by the NAS-process, the adjusted and/or fine-tuned network architecture of each one of the set of candidate neuronal networks to a framework,
generating, by the NAS-process, software code for each one of the converted set of candidate neuronal networks,
evaluating a performance for each one of the code-generated set of candidate neuronal networks;
providing the evaluated set of candidate neuronal networks for selection of at least one neuronal network usable for solving the technical problem, and
selecting at least one of the candidate neuronal networks as a trained, evaluated, quantized neuronal network for deployment on the target hardware device.

8. A system for performing an optimized Neural Network Architecture Search (NAS), the system comprising:
an evaluation and computing device configured to perform the following steps:
providing a technical problem definition, the technical problem to be solved by a to be searched set of candidate neuronal networks, a training dataset, a search space, and a seed neuronal network architecture;
generating the set of candidate neuronal networks by a NAS-process based on at least the provided problem definition and/or the search space and/or the seed neuronal network architecture;
selecting, by the NAS-process, quantization characteristics for quantization of each one of the set of candidate neuronal networks based on at least the provided problem definition and/or expert knowledge;
training, by the NAS-process, each one of the set of candidate neuronal networks based on the at least a part of the training dataset;
adjusting and/or fine-tuning, by the NAS-process, a network architecture of each one of the set of trained candidate neuronal networks via Quantization-Aware Training (QAT);
converting, by the NAS-process, the respectively adjusted and/or fine-tuned network architecture of each one of the set of candidate neuronal networks to a framework;
generating, by the NAS-process, software code for each one of the converted set of candidate neuronal networks;
evaluating a performance for each one of the code-generated set of candidate neuronal networks; and
providing the evaluated set of candidate neuronal networks for selection of at least one neuronal network usable for solving the technical problem.

9. A non-transitory computer-readable medium on which is stored program code of a computer program for performing an optimized Neural Network Architecture Search (NAS), the program code, when executed by a computer, causing the computer to perform the following steps:
providing a technical problem definition, technical problem to be solved by a to be searched set of candidate neuronal networks, a training dataset, a search space, and a seed neuronal network architecture;
generating the set of candidate neuronal networks by a NAS-process based on at least the provided problem definition and/or the search space and/or the seed neuronal network architecture;
selecting, by the NAS-process, quantization characteristics for quantization of each one of the set of candidate neuronal networks based on at least the provided problem definition and/or expert knowledge;
training, by the NAS-process, each one of the set of candidate neuronal networks based on the at least a part of the training dataset;
adjusting and/or fine-tuning, by the NAS-process, a network architecture of each one of the set of trained candidate neuronal networks via Quantization-Aware Training (QAT);
converting, by the NAS-process, the adjusted and/or fine-tuned network architecture of each one of the set of candidate neuronal networks to a framework;
generating, by the NAS-process, software code for each one of the converted set of candidate neuronal networks;
evaluating a performance for each one of the code-generated set of candidate neuronal networks; and
providing the evaluated set of candidate neuronal networks for selection of at least one neuronal network usable for solving the technical problem.
